(19) United States
(12) Patent Application Publication
(10) Pub. No.: US 2011/0285047 A1
(43) Pub. Date: Nov. 24, 2011

(54) METHOD AND DEVICE OF FABRICATING THREE DIMENSIONAL SCAFFOLDS

(76) Inventors: Keng-Hui LIN, Taipei (TW); Wei-Jung Hong, Tao-yuan County (TW)

(21) Appl. No.: 13/197,140

(22) Filed: Aug. 3, 2011

Related U.S. Application Data
(63) Continuation-in-part of application No. 12/582,575, filed on Oct. 20, 2009.

(51) Int. Cl. B29C 44/00

(52) U.S. Cl. 264/50; 425/4 R

(57) ABSTRACT

A method of fabricating three-dimensional scaffolds includes the steps of forming a plurality of bubbles by providing a gelatin solution and a gas stream passing through a bubble production device, gathering the bubbles, cooling the bubbles, crosslinking the bubbles by adding the agent with aldehyde group, and breaking at least some of the bubbles to be interconnected to form a three-dimensional porous materials.

### CROSS REFERENCE TO RELATED APPLICATIONS

This Non-provisional application is a continuation-in-part application of U.S. Non-provisional application Ser. No. 12/582,575 entitled “FABRICATING SCAFFOLDS AND OTHER CELL-GROWTH STRUCTURES USING MICROFLUIDICS TO CULTURE BIOLOGICAL SAMPLES”, filed Oct. 29, 2009, and incorporated herein by reference.

### BACKGROUND OF THE INVENTION

1. Field of Invention

The present invention relates to a method and an apparatus of fabricating three-dimensional scaffolds and, in particular, to a method and an apparatus of fabricating three-dimensional scaffolds for tissue engineering or cell culture.

2. Related Art

Cell culture and tissue engineering are the critical technologies in the regenerative medicine field. According to these technologies, the particular cells or tissues can be grown in large amount so as to provide enough biological samples for further experiments and analysis. By simulating and providing the essential growing conditions, the cultured cell can derivate to form the specific cell or tissue than has specific function, or form an organ with complete function.

The regenerative medicine can not only solve the problem that the patient has to wait for the organ donation, but also avoid the transplantation rejection of the immune system. However, its development is limited by some critical techniques such as the cell culturing and the stereo scaffolds.

In 3D cell culturing, the scaffold provides a very important role for growing the cell into the tissue or organ with desired function and type. The three-dimensional scaffold can provide a three-dimensional frame structure suitable for growing cells. In details, the scaffold has a plurality of pores for attaching or inoculating of the cells, so that the cells can grow based on the designed three-dimensional structure of the scaffold, thereby growing the mimic regenerated tissue or organ.

The conventional method for fabricating the scaffolds is to create a plurality of spheres, deposit the scaffold material, and then remove the spheres after the scaffold material is solidified. This can make a plurality of pores with the same volumes of the removed spheres, so that the cells can attach to or inoculate on the pores. The sphere removal process is slow and tedious. In addition, it is necessary to manufacture the spheres of another dimension for fabricating another three-dimensional scaffold with another dimension. Also the packing density of spheres is limited in range, at most 74%. Thus, the fabrication cost of this method is very expensive, and the fabrication time thereof is longer.

Therefore, it is an important subject of the invention to provide a method and an apparatus for fabricating three-dimensional scaffolds that have less fabrication cost and time.

### SUMMARY OF THE INVENTION

In view of the foregoing, an objective of the invention is to provide a method and an apparatus for fabricating three-dimensional scaffolds that have less fabrication cost and time.

To achieve the above objective, the invention discloses a method of fabricating three-dimensional scaffolds. The method includes the following steps of: forming a plurality of bubbles by providing a gelatin solution and a gas stream passing through a bubble production device; gathering the bubbles; cooling the bubbles; crosslinking the bubbles by adding crosslinking agents with aldehyde groups; and breaking at least some of the bubbles to be interconnected to form the three-dimensional scaffolds.

In one embodiment of the invention, the crosslinking agent with an aldehyde group including glutaraldehyde or paraformaldehyde, or the mixture of the crosslinking agent can tune the properties of the scaffolds such as the stiffness.

In one embodiment of the invention, the method further includes a step of immersing the bubbles in a washing liquid.

In one embodiment of the invention, the method further includes a step of washing with phosphate-buffered saline, clean water, an isotonic solution, or an isotonic culture solution.

In one embodiment of the invention, the step of breaking at least some of the bubbles is to immerse the bubbles in a liquid in low pressure and then degas to remove gas inside the bubbles.

In one embodiment of the invention, the gas stream includes nitrogen, fluorine-contained gas, inert gas, or air.

In one embodiment of the invention, the method further includes a step of fluorescent labeling the three-dimensional scaffolds. The step of fluorescent labeling is performed with a fluorescent dye capable of reacting with an amino group.

In one embodiment of the invention, the bubble production device includes and air channel for air stream, and two gel supply channels converging together with the air channel to form a single outlet channel. The gelatin solution flows through the gel supply channels, and the gas stream flows through the air channel.

To achieve the above objective, the invention also discloses an apparatus of fabricating three-dimensional scaffolds. The apparatus includes a bubble production device, a gelatin solution supply unit, and a bubble collection device. The bubble production device includes an air channel and two gel supply channels. The gel supply channels and the air channel are converged together to form a single outlet channel. The bubble collection device is connected with the outlet channel of the bubble production device.

In one embodiment of the invention, the bubble collection device includes a bottom plate having a plurality of recesses for accommodating the bubbles.

In one embodiment of the invention, the bubble collection device includes a top plate tightly connected with the bottom plate for covering the recesses.

In one embodiment of the invention, the recesses are disk-shaped, elliptic, or polygonal.

In one embodiment of the invention, the recesses are connected or disconnected with each other.

As mentioned above, the present invention can provide the gelatin solution and gas stream to pass through a bubble production device so as to form a plurality of bubbles, add the agent with an aldehyde group for performing the cross-link reaction, and then breaking some of the bubbles to be interconnected to form the three-dimensional scaffolds. In addition, the present invention can control the flow rates of the gelatin solution and gas stream for changing the dimensions of the bubbles. Accordingly, it is a simple and fast method for fabricating the three-dimensional scaffolds. Moreover, the gelatin solution is cheap and easy to prepare, and the suitable operation conditions for forming the bubbles from the gelatin solution are also disclosed in the following embodiment. Thus, the fabrication cost of the three-dimensional scaffolds can be decreased. Besides, under the suitable operation conditions, the fabricated three-dimensional scaffolds can have the pores with substantially same size. This can prevent the analyze result from being affected by the structural variations of the pores in the scaffolds.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The invention will become more fully understood from the detailed description and accompanying drawings, which are given for illustration only, and thus are not limitative of the present invention, and wherein:

FIG. 1 is a flow chart showing a method of fabricating three-dimensional scaffolds of the present invention;

FIG. 2A is a perspective diagram of the bubble production device of the present invention;

FIG. 2B is an enlarged view of the circle A shown in FIG. 2A;

FIG. 2C is a schematic diagram showing the bubble collection device according to the embodiment of the present invention;

FIG. 2D is a schematic diagram showing another aspect of the bubble collection device according to the embodiment of the present invention;

FIG. 3A is a cross-sectional view from the top and the side of the three-dimensional scaffolds observed by using the optical microscope;

FIG. 3B is a perspective diagram and a partial enlarged diagram of the three-dimensional scaffolds fabricated by the method according to the embodiment of the present invention;

FIG. 3C is a graphic diagram showing the emission spectrums vs. the intensities while using the agents with different aldehyde groups to perform the cross-link reaction; and

FIGS. 4A and 4B are cross-sectional views of the scaffolds before and after the C2C12 cells exposure to differentiation medium, which are observed by using the fluorescent microscope.

### DETAILED DESCRIPTION OF THE INVENTION

The present invention will be apparent from the following detailed description, which proceeds with reference to the accompanying drawings, wherein the same references relate to the same elements.

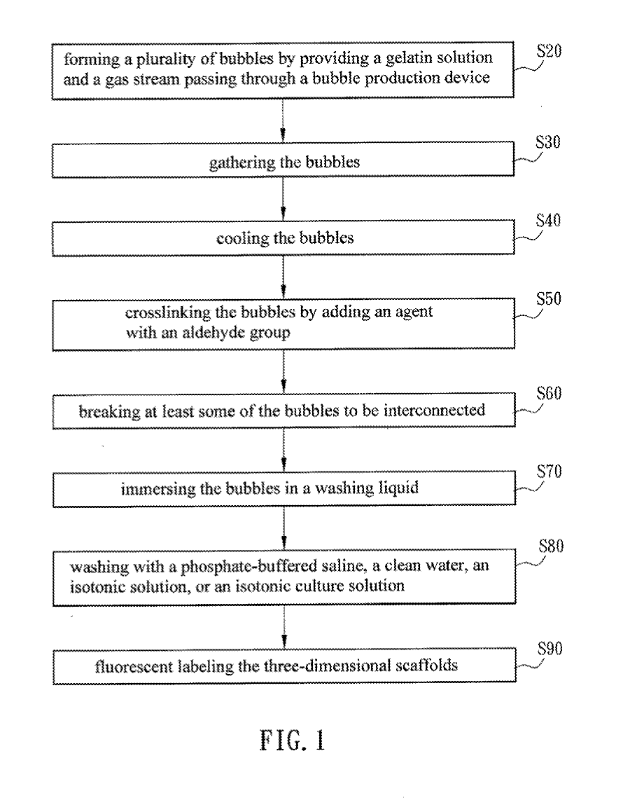

FIG. 1 is a flow chart showing a method of fabricating three-dimensional scaffolds of the present invention. Referring to FIG. 1, the method of fabricating the three-dimensional scaffolds of the present invention includes the following steps of: forming a plurality of bubbles by providing a gelatin solution and a gas stream passing through a bubble production device (step S20); gathering the bubbles (step S30); cooling the bubbles (step S40); crosslinking the bubbles by adding an agent with an aldehyde group (step S50); and breaking at least some of the bubbles to be interconnected to form the three-dimensional scaffolds (step S60).

In the step S20, the gelatin solution is prepared by dissolving the gelatin powder in water so as to form the desired gel solution. The high viscosity of the gelatin solution can facilitate the formation of the bubbles. The amount of the gelatin in the gelatin solution can be adjusted according to the formation of the bubbles. In general, the amount of the gelatin in the gelatin solution is slightly less than 10% of the gelatin solution in weight. In addition, the gas stream is preferably generated by flowing the gas with higher chemical stability, such as nitrogen, fluorine-contained gas, inert gas, or air.

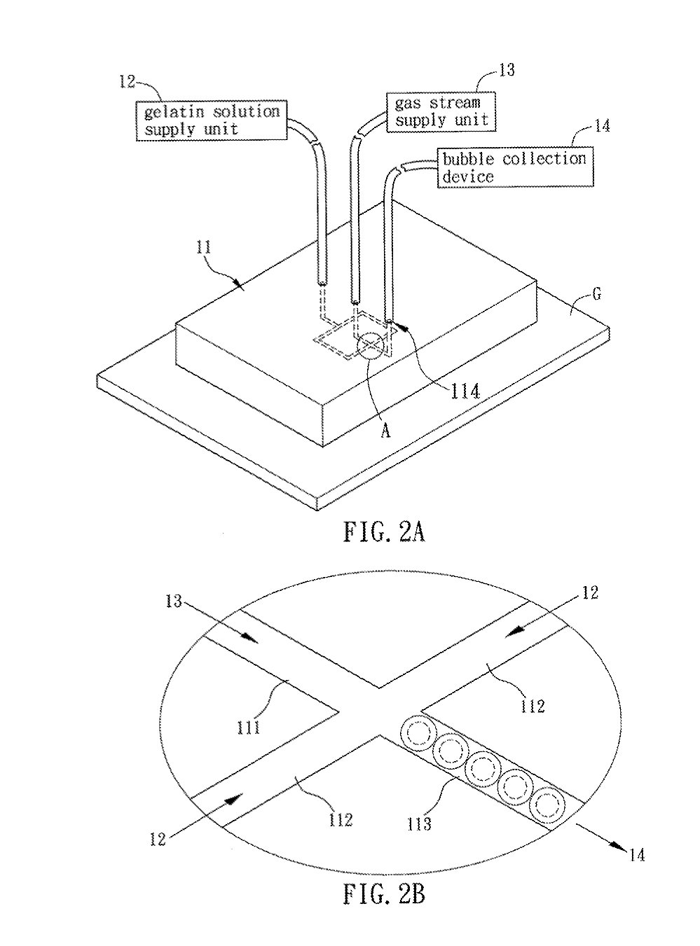

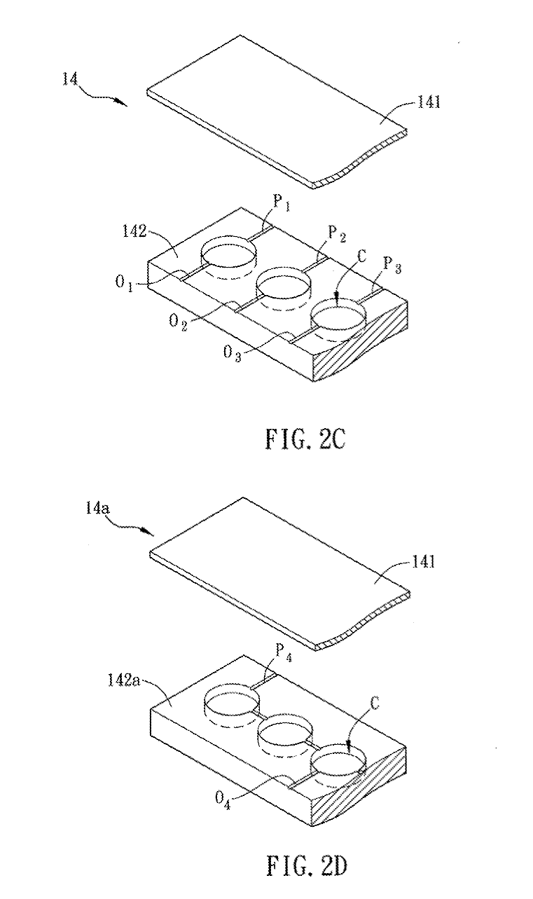

Then, the bubble production device 11 will be described with reference to FIGS. 2A and 2B. FIG. 2A is a perspective diagram of the bubble production device 11, and FIG. 2B is an enlarged view of the circle A shown in FIG. 2A.

In the step S20, a gelatin solution and a gas stream are provided to pass through the bubble production device 11 so as to form a plurality of bubbles. To be noted, the bubble production device 11 can be any device that can generate bubbles by the gelatin solution and gas stream flowing therethrough. Herein, the bubble production device 11 can be fabricated by performing a patterning process with the gel, thereby forming through holes and channels on a bottom surface, and then disposing a glass plate G to cover the bottom of the bubble production device 11. Of course, the bubble production device 11 may have a planar geometry of cross-flow or a dual-channel structure (including an air channel and two gel supply channels). In this embodiment, the bubble production device 11 has the planar crossflow with dual channels. In more detailed, the bubble production device 11 includes an air channel 111, two gel supply channels 112, and an outlet channel 113. The air channel 111 and the gel supply channels 112 converge together and connect to the outlet channel 113. The configurations of the air channel 111 and the gel supply channels 112 as well as the angels therebetween depend on the actual requirements. Preferably, the air channel 111 is disposed between the gel supply channels 112, and the two gel supply channels 112 are symmetrically configured. In this embodiment, the direction of the gel supply channels 112 is substantially perpendicular to the air channel 111. In operation, a gelatin solution supply unit 12 is connected with a main channel, which is then divided into two gel supply channels 112, and a gas stream supply unit 13 is connected with the air channel 111. In other words, the gelatin solution flows through the two gel supply channels 112, and the gas stream flows through the air channel 111. The bubbles are formed at the junction of the air channel 111 and the gel supply channels 112 and then outputted through the outlet channel 113. In this embodiment, the air channel 111 and the gel supply channels 112 are joined together and then connected to the outlet channel 113.

The gelatin solution supply unit 12 is used to provide the gelatin solution to the bubble production device 11 for forming the bubbles. It can be any device that is, for example but not limited to, a tank with the storage function and capable of simply loading the gelatin solution and supplying it to the gel supply channels 112. There is no specific limitation to the structure and shape of the device for supplying the gelatin solution. Preferably, the gelatin solution supply unit 12 can protect the inside gelatin solution from pollution, and have the functions of adjusting the output pressure, flowing speed, and/or output amount per unit time of the gelatin solution. Besides, in order to maintain the temperature of the gelatin solution, which may be congealed if its temperature is too low, a heating device for keeping the temperature of the gelatin solution between 45° C. and 60° C. Thus, the gelatin solution can not be congealed neither in the gelatin solution supply unit 12 nor in the gel supply channels 112 during the supplying.

The gas stream supply unit 13 is used to provide the gas stream to the bubble production device 11 for forming the bubbles. Similarly, the gas stream supply unit 13 can be any device that is, for example but not limited to, a tank with the storage function and capable of simply loading the gas and supplying it to the air channel 111. There is no specific limitation to the structure and shape of the device for supplying the gelatin solution. Preferably, the gas stream supply unit 13 can protect the inside gas from pollution, and have the functions of adjusting the output pressure, flowing speed, and/or output amount per unit time of the gas stream. By controlling the gas stream supply unit 13, it is possible to easily adjust the size of the bubbles in the three-dimensional scaffolds. In this embodiment, the volume of the gas is about 50% and higher of that of the three-dimensional scaffolds.

Besides, in this embodiment of preparing the three-dimensional scaffolds, the environment parameters and operation conditions for forming the bubbles must also be considered. The region of the considered environment parameters and operation conditions includes the gelatin solution supply unit 12, the gas stream supply unit 13, and the air channel 111 and the gel supply channels 112 of the bubble production device 11. The environment parameters and operation conditions may include, for example, the flow rate of the gelatin solution, the output pressure of the gas stream, the relative locations of the air channel 111 and the gel supply channels 112, and the likes. In other words, all environment parameters and operation conditions relative to the formation of the bubbles must be controlled so as to produce the optimum bubbles. Herein, the output pressure of the gas stream from the air channel 111 and the flow rate of the gelatin solution are the most critical parameters, and they must be carefully controlled.

To be noted, the above-mentioned bubble production device 11, the gelatin solution supply unit 12, the gas stream supply unit 13, and an additional bubble collection device 14 can construct the apparatus of fabricating three-dimensional scaffolds of the invention. Their connections are described hereinabove, so the detailed description thereof will be omitted.

FIGS. 2C and 2D are schematic diagrams showing the bubble collection devices according to the embodiment of the present invention. The bubble collection device 14 includes a top plate 141 and a bottom plate 142. The bottom plate 142 has a plurality of recesses C for accommodating the bubbles, and the top plate 141 is tightly connected with the bottom plate 142 for covering the recesses C. In the step S30, the bubble collection device 14 is connected with the outlet channel 113 of the bubble production device 11, so that the bubbles formed by the bubble production device 11 can flow to the recesses C of the bottom plate 142 through the outlet channel 113. Thus, the bubbles can be gathered in the recesses C and they can be automatically closely arranged. Of course, the following crosslinking step and the cooling step can be directly performed in the recesses C. Accordingly, the manufacturer can obtain the desired three-dimensional scaffolds by only designing the size and shape of the recesses C for gathering the bubbles. In this embodiment, the size of the recesses C is the same as that of the well dish used in labs, and this is convenient for the following experiments (e.g. cell seeding). Herein, the recess C has a disk shape, and it may have, for example but not limited to, an elliptic shape or a polygonal shape. Besides, each recess C may connect or disconnect to another adjacent recess C. For example, as shown in FIG. 2B, if the recesses C of the bottom plate 142 are not connected with each other, it is necessary to configure separate inlets P₁, P₂, P₃ for each of recesses C respectively, and the bubble production device 11 must output the bubbles to the recesses C through the separate inlets P₁, P₂, P₃. In addition, it is also needed to configure the outlets O₁, O₂, O₃ corresponding to the inlets P₁, P₂, P₃, so that the exceeding bubbles can flow out through the outlets O₁, O₂, O₃. Alternatively, as shown in FIG. 2C, if the recesses C of the bottom plate 142a are connected with each other, it only need to configure a single inlet P₄, and the bubbles can be transmitted to all of the recesses C through the connection channels between the recesses C. In addition, it is also needed to configure one outlet O₄ in one of the recesses C, so that the exceeding bubbles can flow out through the outlet O₄. This configuration is much convenient and faster in operation.

Referring to FIG. 2B again, in order to create the suitable environment for growing cells, the diameter of the bubbles produced by the bubble production device 11 is between 50 μm and 500 μm, and it is preferably between 60 μm and 90 μm.

With reference to FIG. 1 again, the method of fabricating three-dimensional scaffolds of the invention further includes a step of cooling the bubbles (step S40). In this case, the cooling temperature is slightly lower than the room temperature for performing the crosslinking of the gelatin. In this embodiment, the bubble collection device is disposed at about 4° C. for speeding the cooling of the bubbles. Besides, the cooling step S40 may be performed simultaneous as or after the step S50 for crosslinking the bubbles. The invention is not to limit the order of the steps.

In the step S50, a crosslinking agent with an aldehyde group is added to perform a cross-link reaction. The cross-link reaction is to induce the chemical or physical changes between bubbles, so that the bubbles walls can link with each other. Thus, the relative positions of adjacent bubbles can be fixed by the cross-link reaction. In the macroscopic point of view, the cross-link reaction can make the bubble walls of the stacked bubbles (preferably automatically stacked in close arrangement) be transformed from the original viscose liquid gelatin solution to a three-dimensional cross-linked structure, thereby forming the desired three-dimensional scaffolds. In this embodiment, the crosslinking agent with an aldehyde group includes glutaraldehyde, paraformaldehyde, or any other suitable agent for performing the crosslinking reaction. The crosslinking agent or the mixture of the crosslinking agent can tune the properties of the scaffolds such as the stiffness. In the current embodiment, the solution containing 2% of glutaraldehyde or paraformaldehyde is added to initiate the cross-link reaction.

In the step S60, at least some of the bubbles are broken so that the adjacent bubbles can be interconnected. In this embodiment, the step of breaking at least some of the bubbles is to dispose the bubbles under a low pressure (less than 20 torr), immerse the bubbles in a liquid, and then degas to remove the gas inside the bubbles. The bubbles can be broken by pressure difference so as to make the closed-cell foam become the open-cell foam. In more detailed, this step may to immerse the cross-linked structure after the crosslinking step into the liquid. Since the gas pressure of the external environment is smaller than that inside the bubbles, the gas may be automatically released from the scaffolds, and then the liquid may fulfill the gaps between the scaffolds.

In this embodiment, the method of fabricating the three-dimensional scaffolds may further include a step of: immersing the bubbles in a washing liquid (step S70). In this step S70, the bubbles are immersed in 1M glycine solution or 0.5% sodium borohydride solution for 1 hr so as to wash the residual non-reacted aldehyde agent or other crosslinking agent. Herein, the sodium borohydride solution can remove some fluorescent parts of the three-dimensional scaffolds made by gelatin. This can avoid the undesired interference in the following observation step.

The method of fabricating the three-dimensional scaffolds may further include a step of: washing with phosphate-buffered saline, clean water, an isotonic solution, or an isotonic culture solution (step S80). In this embodiment, the three-dimensional scaffolds are washed by the phosphate-buffered saline 3 times (for 1 hr in each washing), so that the three-dimensional scaffolds can provide an environment suitable for the following cell culture.

Besides, the method of fabricating the three-dimensional scaffolds may further include a step of: fluorescent labeling the three-dimensional scaffolds (step S90). The step S90 is to use a fluorescent dye capable of reacting with an amino group to perform the fluorescent labeling, so that the portions to be observed can be easily identified. In this embodiment, in order to make the observation of the three-dimensional scaffolds more easier, the three-dimensional scaffolds can be labeled with 0.01 mg/ml fluorescein isothiocyanate or Cy5 N-hydroxysuccinimide ester dissolved in pH 9.5 buffer containing 0.125M sodium bicarbonate and 0.2 M NaCl for an hour.

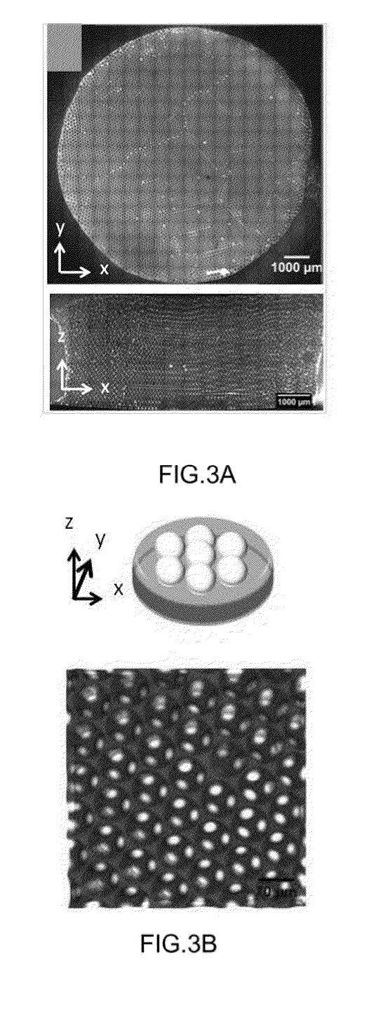

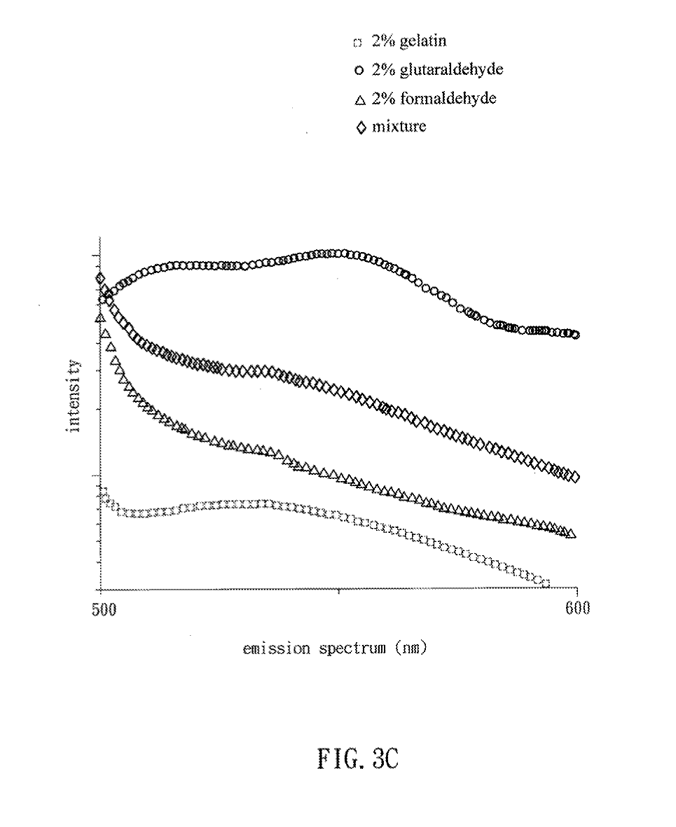

FIG. 3A is a cross-sectional view from the top and bottom of the three-dimensional scaffolds observed by using the optical microscope, FIG. 3B is a perspective diagram and a partial enlarged diagram of the three-dimensional scaffolds fabricated by the method according to the embodiment of the present invention, and FIG. 3C is a graphic diagram showing the emission spectrums vs. the intensities while using the agents with different aldehyde groups to perform the cross-link reaction. Referring to FIG. 3C, the curve of the squares represents the emission spectrum of uncrosslinked gelatin, the curve of the circles represents the emission spectrum of the gelatin crosslinked with 2% glutaraldehyde, the curve of the triangles represents the emission spectrum of the gelatin crosslinked with 2% formaldehyde, and the curve of the diamonds represents the emission spectrum of the gelatin crosslinked with a mixture of 0.1% glutaraldehyde and 2% paraformaldehyde. According to FIG. 3C, gelatin crosslinked by 2% glutaraldehyde emits strongest autofluorescence, which can be reduced by substituting glutaraldehyde with 2% paraformaldehyde or a mixture of 0.1% glutaraldehyde and 2% paraformaldehyde. This can avoid the undesired interference in the following observation step.

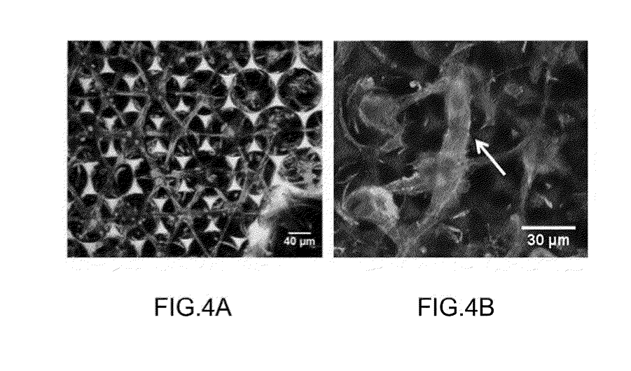

FIGS. 4A and 4B are cross-sectional views of the scaffolds before and after the C2C12 cell, a myogenic cell line derived from mouse skeletal muscles, exposure to differentiation medium, which are observed by using the fluorescent microscope. The images of FIGS. 4A and 4B are processed in Imaris version 7.1 software (Bitplane) and the operations involved are adjusting contrasting and brightness and being smoothed with Gaussian kernel.

As shown in FIG. 4A, C2C12 myoblasts (myogenic cell line) are cultured in DMEM (Dulbecco's Modified Eagle Medium, Gibco) supplemented with 10% CBS (calf bovine serum, Gibco) and 1% antibiotics (e.g. penicillin and streptomycin, Gibco). All cell cultures are maintained at 37° C. and 5% CO₂, and the medium is exchanged every other day. After cell culturing in the scaffolds for 1 day, the cell staining is then performed. The cells are fixed in 4% paraformaldehyde and 0.1% Triton X in PBS for 15 minutes at room temperature. The F-actin and nuclei of the cultured cell are stained with fluorescent phalloidin and DAPI (4′,6-diamidino-2-phenylindolc), respectively, and are imaged with an LSM510 confocal microscope. The cultured cells are imaged with a FluoView FV1000 microscope (Olympus). After only one day of cell culture in the scaffolds and prior to the addition of differentiation medium, some C2C12 cells grow on the curved pore surfaces, while other cells stretched into line by forming strong contacts with other cells in neighboring pores. Lines of cells often grow along the crystalline structure of the scaffolds and exhibit a striking aster pattern, suggesting that the scaffold itself may initiate the differentiation process in C2C12 cells.

Besides, as shown in FIG. 4B, in order to induce myotube formation, the culture medium for differentiation medium is exchanged from the original 10% CBS to 10% HS (horse serum) after the linear patterns are formed. The cells fused inside the scaffolds can be observed after culturing gin differentiation medium for more than 10 days, and a thick fused myotube with multiple nuclei appears after culturing with differentiation medium for more than one month. Despite the spherical shape of the scaffold pores, the C2C12 cells, which are tubular in the natural setting of the animal body, preserves and exhibits underlying physiological characteristics consistent with observations of their growth in two-dimensional culture. Accordingly, the three-dimensional scaffolds of the invention can provide an ideal culture model because each pore represents an identical microenvironment. Under these uniform mechanical conditions, the myoblasts may contact each other in a linear fashion and fused into a clearly recognizable myotube. Cells grown in these scaffolds can be trypsinized and collected for downstream analysis, including gene expression analysis.

In summary, the present invention can provide the gelatin solution and gas stream to pass through a bubble production device so as to form a plurality of bubbles, add the agent with an aldehyde group for performing the cross-link reaction, and then breaking some of the bubbles to be interconnected to form the three-dimensional scaffolds. In addition, the present invention can control the flow rates of the gelatin solution and gas stream for changing the dimensions of the bubbles. Accordingly, it is a simple and fast method for fabricating the three-dimensional scaffolds. Moreover, the gelatin solution is cheap and easy to prepare, and the suitable operation conditions for forming the bubbles from the gelatin solution are also disclosed in the following embodiment. Thus, the fabrication cost of the three-dimensional scaffolds can be decreased. Besides, under the suitable operation conditions, the fabricated three-dimensional scaffolds can have the pores with substantially same size. This can prevent the analyze result from being affected by the structural variations of the pores in the scaffolds.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method of fabricating three-dimensional scaffolds, comprising steps of:
forming a plurality of bubbles by providing a gelatin solution and a gas stream passing through a bubble production device;
gathering the bubbles;
cooling the bubbles;
crosslinking the bubbles by adding an agent with an aldehyde group; and
breaking at least some of the bubbles to be interconnected to form the three-dimensional scaffolds.

2. The method according to claim 1, wherein the agent comprises glutaraldehyde or paraformaldehyde.

3. The method according to claim 1, further comprising a step of:
immersing the bubbles in a washing liquid.

4. The method according to claim 1, further comprising:
washing with phosphate-buffered saline, clean water, an isotonic solution, or an isotonic culture solution.

5. The method according to claim 1, wherein the step of breaking at least some of the bubbles is to immerse the bubbles in a liquid in low pressure and then degas to remove gas inside the bubbles.

6. The method according to claim 1, wherein the gas stream comprises nitrogen, fluorine-contained gas, inert gas, or air.

7. The method according to claim 1, further comprising:
fluorescent labeling the three-dimensional scaffolds.

8. The method according to claim 7, wherein the step of fluorescent labeling is performed with a fluorescent dye capable of reacting with an amino group.

9. The method according to claim 1, wherein the bubble production device comprises an air channel for air stream, and two gel supply channels converging together with the air channel to form a single outlet channel, and the gelatin solution flows through the gel supply channels, and the gas stream flows through the air channel.

10. An apparatus of fabricating three-dimensional scaffolds, comprising:
a bubble production device comprising:
an air channel for air stream,
two gel supply channels converging together with the air channel to form a single outlet channel; and
a bubble collection device connected with the outlet channel of the bubble production device.

11. The apparatus according to claim 10, wherein the bubble collection device comprises a bottom plate having a plurality of recesses for accommodating the bubbles.

12. The apparatus according to claim 11, wherein the bubble collection device comprises a top plate tightly connected with the bottom plate for covering the recesses.

13. The apparatus according to claim 11, wherein the recesses are disk-shaped, elliptic, or polygonal.

14. The apparatus according to claim 11, wherein the recesses are connected or disconnected with each other.
